(19) United States
(12) Patent Application Publication
(10) Pub. No.: US 2018/0088752 A1
(43) Pub. Date: Mar. 29, 2018

(54) MOBILE WEB BROWSER PROVIDING CONTEXTUAL ACTIONS BASED ON WEB PAGE CONTENT

(71) Applicant: Button Inc., New York, NY (US)

(72) Inventors: Michael John Wakerly, New York, NY (US); Sean Joey Summers, San Francisco, CA (US)

(73) Assignee: Button Inc., New York, NY (US)

(21) Appl. No.: 15/718,345

(22) Filed: Sep. 28, 2017

Related U.S. Application Data
(60) Provisional application No. 62/401,137, filed on Sep. 28, 2016.

(51) Int. Cl. G06F 3/0482; G06F 17/30; G06F 17/22

(52) U.S. Cl. CPC G06F 3/0482; G06F 17/30905; G06F 17/2247; G06F 17/2235; G06F 17/30867

(57) ABSTRACT

A Uniform Resource Locator (URL) is received at a server and from a mobile web browser executing on a mobile computing device. At least one contextual action is identified based on at least content of a web page associated with the URL. At least one service provider associated with the at least one contextual action is identified. At least one service provider is communicated with for inventory information associated with the at least one contextual action. At least one data object including information associated with the at least one contextual action and the inventory information is sent to the mobile web browser.

### CROSS-REFERENCE TO RELATED APPLICATIONS

This application claims the benefit of priority to U.S. Provisional Patent Application Ser. No. 62/401,137, filed Sep. 28, 2016, the contents of which are hereby incorporated by reference.

### BACKGROUND

Mobile computing device (MCD) browsers usually discover content through Uniform Resource Locators (URLs) that specify the location of a content resource in a network and form connections that transform the network (for example, the Internet) into a network of discovery and utility. For example, when a user clicks a hyperlink in a browser document (for example, a web page or content resource), a URL contained within the hyperlink takes a user from one web page or content resource in the web to another web page or content resource in the web. Typically, URLs are explicitly added to content resources. Manually inserted URLs can be coded by a software developer or inserted by a web page creation software application and are considered static in nature (meaning the content referenced by the URL remains the same as long as changes are not made to the reference content). In comparison, dynamic URLs can reference content that can be dynamically generated as the result of a search on a content server driven by a database executing, for example, scripts to generate content.

URL's defined within web content are primarily platform independent and devoid of knowledge of the existence of native mobile applications that are available beyond the boundaries of a mobile browser executing on the MCD. As a result, a native mobile application that may offer a better next-action utility to a user following selection of a hyperlink is not utilized to improve the user's overall browsing experience.

### SUMMARY

The present disclosure describes providing contextual actions based on web page content.

In an implementation, A Uniform Resource Locator (URL) is received at a server and from a mobile web browser executing on a mobile computing device. At least one contextual action is identified based on at least content of a web page associated with the URL. At least one service provider associated with the at least one contextual action is identified. At least one service provider is communicated with for inventory information associated with the at least one contextual action. At least one data object including information associated with the at least one contextual action and the inventory information is sent to the mobile web browser.

Implementations of the described subject matter, including the previously described implementation, can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented in particular implementations so as to realize one or more of the following advantages. First, the described subject matter can enhance a user's experience with a mobile application by enabling the user to view inventory information from a third-party mobile application without the user leaving the mobile application he is currently in. Second, the described approach improves utility of a web page of a mobile application by predicting actions relevant to the content of the web page and presenting the actions to the user within the mobile application (that is, rendering the actions natively within the mobile application). Third, the described approach permits rendering of actions natively at the mobile application level and improving attribution with third party applications (for example, and attributing commerce activity to an originating mobile application and/or web publisher). Other advantages will be apparent to those of ordinary skill in the art.

The details of one or more implementations of the subject matter of this specification are set forth in the Detailed Description, the Claims, and the accompanying drawings. Other features, aspects, and advantages of the subject matter will become apparent from the Detailed Description, the Claims, and the accompanying drawings.

### DESCRIPTION OF DRAWINGS

FIG. 1 is a block diagram illustrating an example of a distributed computing system that provides contextual actions based on web page content, according to an implementation.

FIGS. 2A and 2B are flow charts illustrating an example of a method for providing contextual actions based on web page content, according to an implementation.

FIG. 3 is a flow chart illustrating an example of a method for a backend server identifying contextual relevant actions, according to an implementation.

FIG. 4 is a flow chart illustrating an example of a method for a backend server prioritizing contextual actions, according to an implementation.

FIG. 5 is a block diagram illustrating an example of a computer-implemented system used to provide computational functionalities associated with described algorithms, methods, functions, processes, flows, and procedures, according to an implementation of the present disclosure.

FIG. 6 is a block diagram illustrating an example of a mobile computing device according to an implementation.

Like reference numbers and designations in the various drawings indicate like elements.

### DETAILED DESCRIPTION

The following detailed description describes a mobile web browser that provides contextual actions based on web page content, and is presented to enable any person skilled in the art to make and use the disclosed subject matter in the context of one or more particular implementations. Various modifications, alterations, and permutations of the disclosed implementations can be made and will be readily apparent to those or ordinary skill in the art, and the general principles defined can be applied to other implementations and applications, without departing from the scope of the present disclosure. In some instances, details unnecessary to obtain an understanding of the described subject matter can be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

Mobile computing device (MCD) (for example, smart phones, tablet computers, etc.) browsers usually discover content through Uniform Resource Locators (URLs) that specify the location of a content resource in a network and form connections that transform the network (for example, the Internet) into a network of discovery and utility. For example, when a user clicks a hyperlink in a browser document (for example, a web page or content resource), a URL contained within the hyperlink takes a user from one web page or content resource in the web to another web page or content resource in the web. Typically, URLs are explicitly added to content resources. Manually inserted URLs can be coded by a software developer or inserted by a web page creation software application and are considered static in nature (meaning the content referenced by the URL remains the same as long as changes are not made to the reference content). In comparison, dynamic URLs can reference content that can be dynamically generated as the result of a search on a content server driven by a database executing, for example, scripts to generate content.

URLs defined within web content are primarily platform independent and devoid of knowledge of the existence of native mobile applications that are available beyond the boundaries of a mobile browser executing on a MCD. As a result, a native mobile application that may offer a better next-action utility to a user following selection of a hyperlink is not utilized to improve the user's overall browsing experience.

Described is a mobile web browser that is configured to augment next-action URLs found on a web page with relevant and contextual commerce actions (for example, with buttons or other graphical user interface (GUI) elements) that are rendered at a native mobile browser level. The mobile web browser sends a URL of an in-use web page to a backend server or service. In addition, knowledge of a real-time inventory of available commerce actions provided by a network of commerce provider application programming interfaces (APIs) and next-action intent inferred from information included with the web page associated with the sent URL is used to provide recommended contextual browsing actions to a user.

In other words, the backend server can predict of-interest next actions to the user based on the content of the user's web page, identify service providers that can fulfill predicted next actions, collect inventory information from the service provider APIs, and send the next actions and inventory information to the mobile web browser for rendering. The mobile web browser presents the next actions to the user (for example, using buttons as described above), and the user can view the relevant inventory information without switching from the mobile web browser to a particular service provider's native application. Interaction with a provided next-action GUI element or with associated real-time inventory (for example, to setup a meal reservation or to make a purchase) results in a deeplink action into a commerce provider's relevant native mobile application or a link to the commerce provider's mobile website. In some implementations, the interaction can be configured to be completed entirely within the native functionality of the mobile browser so that a user does not have to leave the mobile browser environment.

At a high-level, the described functionality is:
1) A user's mobile browser is a native standalone application or is a browser rendered within a mobile application A (for example, mobile GOOGLE CHROME, MOZILLA FIREFOX, APPLE SAFARI, etc.) executing in a MCD. Web page A is rendered in the mobile browser. At the same time (for example, in parallel) that the mobile browser renders web page A to be viewed by the user, the mobile browser sends a request to a backend service with the URL of web page A along with relevant user-specific information (for example, user location, a user identifier associated with a service provider, type and operating system of the MCD). The mobile browser requests that the backend service return a data object comprising a list of contextually-relevant commerce actions and the service providers that are equipped to fulfill the contextually-relevant commerce actions.
2) The backend service identifies highly-relevant next-action commerce use cases associated with the URL as a list of potential next-action user cases. These use cases are identified by evaluating the content of the web page (for example, metadata, text, links, images, etc.) and computing a measure of next-action contextual utility (an “action index”). In some cases, the use cases can also be identified based on user-specific information or derived intent strength. Use cases meeting a particular threshold (for example, measuring above or at/above a predetermined lower threshold) are considered.
3) Given an identified list of potential next-action use cases, the backend service determines real-time inventory using provider APIs for service providers that are known to fulfill at least one of the potential use cases.
4) Based on the list of potential next-action use cases, the queried real-time inventory, and any additional (optional) information (for example, user location), the backend service identifies particular next-actions to return. The backend service compiles a data object to include with the response to the parallel request from the mobile browser. Upon receipt of the data object, the mobile browser renders the next actions as visible to the user. Interaction with the rendered next actions allows the user to preview inventory, link to service providers (for example, using a native application or mobile web browser application) that are equipped to fulfill a desired next action, and in some instances complete the desired next action within the native functionality of the mobile browser.

As a particular example to provide additional perspective and understanding of the prior and following description, consider a user browsing the web using a mobile browser on a MCD. The user searches for a restaurant that has been recommended to them and that they have heard others talking about. The user navigates to the official home page for the restaurant, which provides operating hours, location, phone number, and menu information. However, the official home page does not provide any URL's for continued discovery or fulfillment of the user's next intended action (for example, to order food for deliver, set up a taxi ride to the restaurant, make a reservation, etc.).

At the time the user browsed to the official home page web page, the mobile browser communicated in parallel with a backend service and requested a list of contextual commerce actions associated with the current web location (that is, the restaurant's official home page). The backend service, using the URL as input (including the user-relevant information), is able to infer that transportation, food delivery, and restaurant reservations are potentially likely and highly-contextual commerce next actions associated with the current web page and the user. The backend service returns a list of the next actions in a response to the parallel request to the mobile browser. The next actions included in the response are formulated by considering, for example and among other things, the availability of inventory (such as: Does the restaurant deliver food? Is a food delivery service available and open to deliver from the restaurant? Are taxis or third-party transportation services operating and do they have available vehicles for transportation?, etc.) and a derived intent strength for the user. The intent strength can be determined by the context derived from web page, user-specific information, such as user location, or non-user specific information, such as time of day, or other data consistent with this disclosure (or a combination of these or other data types).

Upon receiving the response from the backend service, the mobile browser renders the contextually-relevant commerce (next) actions visible to the user in an unobtrusive manner (for example, as buttons integrated into a rendered web page or in a particular location(s) that the user can access or ignore). The commerce actions (next action options) that are presented to the user augment the utility of the web page for the user. For example, the surfaced next actions (in the context of this example) can include the following:
Transportation: Options and actions are returned that enable the user to preview ride-hailing options from their current location (for example, as determined using location services on the MCD or other location determination methods) to the location of the restaurant. In addition to available service providers, the user can be provided expected travel time, the type of car that will carry them, and the estimated cost of the service.
Food Delivery: Options and actions are returned that enable the user to preview food delivery options from the restaurant. In addition to available service providers, the user can be provided expected delivery time as well as menu items that are available to order.
Reservation: Options and actions are returned that enable the user to book a reservation at the restaurant. In addition to the service provider, the user is provided available reservation times and party size at the restaurant.

In this example, the user is interested in dining at the restaurant that evening. After exploring reservation options, the user chooses a time and party size that fits their needs. The user is deeplinked into a native application of a service provider that can provide reservation functionality for the user's geographic area to complete the reservation action (for example, OPENTABLE, WEBERVATIONS, PLANYO, etc.).

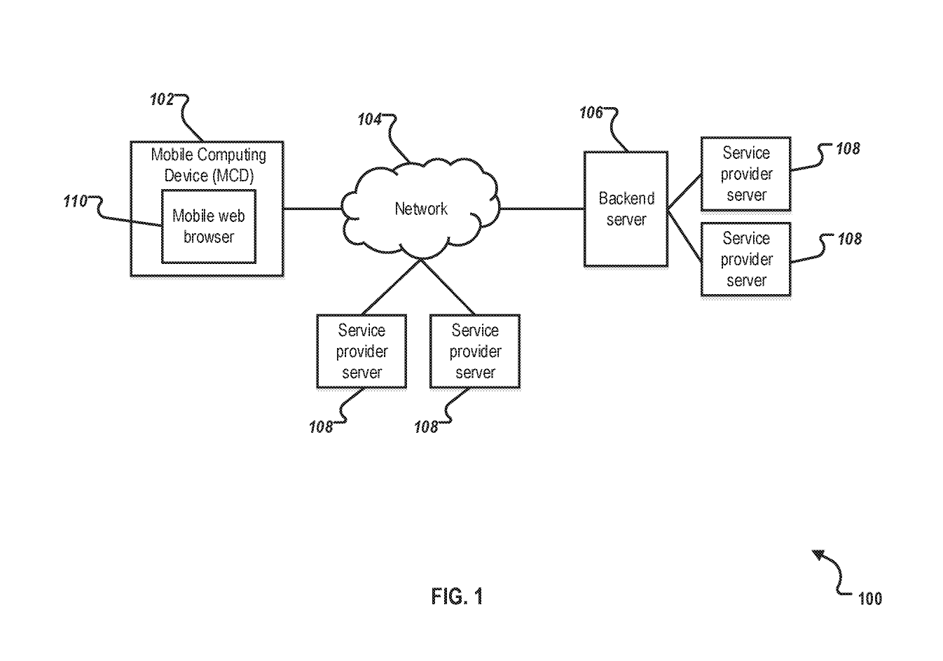

FIG. 1 is a block diagram illustrating an example of a distributed computing system (EDCS) 100 that provides contextual actions based on web page content, according to an implementation. The example EDCS 100 includes a MCD 102 (for example, the MCD described above) with a mobile web browser 110. The MCD 102 can connect to a backend server 106 (for example, providing “backend services” as describe above) through a network 104. The network 104 and the backend server 106 can further connect to one or more service provider servers 108 associated with one or more service providers. In some implementations, the mobile web browser 110 can be a native standalone application on the MCD 102, for example, a standalone web browser installed on the MCD 102, similar to the GOOGLE CHROME, MOZILLA FIREFOX, or APPLE SAFARI web browser. In some implementations, the mobile web browser 110 can be a web browser rendered within a mobile application. When a user uses the mobile application, web pages of the mobile application will be rendered on the mobile web browser 110.

The mobile web browser 110 can send the URL of a web page the user is currently accessing to the backend server 106. For example, if the mobile web browser 110 is a standalone application on the MCD 102, when the user navigates on the web using the mobile web browser 110, the mobile web browser 110 can access and send URLs to the backend server 106. If the mobile web browser 110 is rendered within a mobile application, when the user uses the mobile application and the mobile web browser 110 renders a web page of the mobile application, the mobile web browser 110 can send the URL of the web page to the backend server 106. In some implementations, the mobile web browser 110 can send a request to the backend server 106 requesting a list of actions associated with the web page and include the URL of the web page in the request.

In some implementations, the mobile web browser 110 can also send user-specific information, along with the URL, to the backend server 106. For example, user-specific information can include user location information, user identifiers or account information associated with service providers (that is, third-party user identifier or account information, such as the user's UBER account information), device type and operating system of the MCD 102, and other data consistent with this disclosure. The mobile web browser 110 can send the user location to the backend server 106 (note that the user may be required to opt in for location sharing, for example, by allowing the mobile browser/application access to the user location from the MCD/operating system) to enable retrieval and display of location-based inventory. The user may allow the mobile web browser 110 to share the user's third-party identifiers or account information with the backend server 106 in order to facilitate loyalty (for example, points or cashback) offers and functionalities. The user may also allow the mobile web browser 110 to share device type and operating system of the MCD 102 with the backend server 106 so that the backend service can find appropriate service providers' applications matching the MCD's device type and operating system. The user-specific information can be appended to the request (the request sent by the mobile web browser 110 requesting a list of contextual actions) as standard HTTP POST request data. The mobile web browser 110 may offer the user options whether the user would like to share URL or user-specific information with the backend service. If a user chooses to opt out of location sharing and third-party identifier/account sharing, reduced functionality can be provided, such as reduced loyalty offerings and other functionality. If the user opts out of URL sharing and device/operating system sharing, the functionality of the mobile web browser 110 providing contextual actions can also be disabled in entirety. In some implementations, URL and other information that has been shared with the backend service can be automatically cleared after a short time period (for example, a statically-predefined or dynamically-generated period of time), or can be immediately deleted at the request of the user.

In some implementations, the mobile web browser 110 can request that the backend server 106 return one or more data objects including a list of actions contextually relevant to the content of the web page of the URL and a list of service providers that are equipped to fulfill these actions.

Upon receiving the URL (and the user-specific information), the backend server 106 can identify relevant next-action use cases associated with the URL (that is, actions relevant to the URL that the user might next perform). In some implementations, the backend server 106 can identify relevant next-action use cases by evaluating the content of the web page of the URL (for example, metadata of the web page, text, links, images in the web page, etc.) and computing a measure of contextual utility for each use case. The measure of contextual utility can indicate the relevance between a use case and the context of the URL. In some implementations, the backend server 106 may only consider the use cases having a measure of contextual utility above a predetermined threshold. Given the identified next-action use cases, the backend server 106 can identify service providers that can fulfill the identified next-action use cases and query the service providers for inventory information such as real-time inventory. In some implementations, the backend server 106 may only consider the service providers that are able to provide the service based on inventory availability. In some implementations, the backend server 106 can query the service provider servers 108 through the service providers' APIs for inventory information and availability confirmation data. For example, the backend server 106 can build appropriate API queries based on context data inferred from the web page and knowledge of the API services. In some cases, if the user current location information is not provided, the backend server 116 may query inventory information around the destination.

Based on the identified next-action use cases, the queried inventory, and other information (for example, user-specific information such as user location information, user's third-party identifier or account information, device type, and operating system), the backend server 106 can compile a list of next-actions to return to the mobile web browser 110. For example, the backend server 106 may only include next-actions that can be fulfilled by at least one service provider based on a determined inventory availability. The backend server 106 can compile the actions in a data object and return to the mobile web browser 110. In some implementations, the data object can also include the service providers that can provide the services and associated inventory information. In still other implementations, the compiled data can be returned to the mobile browser 110 in multiple data objects to be assembled by the mobile browser 110.

In some implementations, the backend server 106 can return a prioritized list of next-actions to the mobile web browser 110. For example, for each next-action use case that has been identified, the backend server 106 can iterate through service providers determined to be able to fulfill the use case. The backend server 106 can communicate with the service providers' APIs to obtain real time inventory and determine whether or not the service providers can fulfill the particular use case based on an understanding of available inventory. Action ranking based on inventory can be based on data parameters, primarily related to context and intent that has been inferred from the web page. For example, if the web page is related to dining at a Restaurant A in New York City (NYC), the backend server 106 may determine that there are two potential next-action use cases: 1) make a dinner reservation in NYC and 2) to make a dinner reservation at Restaurant A. By iterating through service providers using queries to service providers' APIs, the backend server 106 may identify two providers that can fulfill at least one of the use cases: 1) Provider A has reservations/restaurants available in NYC, and 2) Provider B has reservations/restaurants in NYC and at Restaurant A. Based on this information, the action/inventory returned by Provider B for the exact restaurant would be ranked above Provider A due to a better match to the context inferred from the current web page. In other words, the backend server 106 will prioritize the action “making a reservation with Provider B” over the action “making a reservation with Provider A”. Now consider a different scenario. If Provider B does not have reservations available at Restaurant A for a couple months and also has a limited supply of restaurants available in NYC, the action/inventory associated with Provider A may be ranked higher than Provider B.

In some cases, the backend server 106 can prioritize next-actions based on user-specific information. For example, if the restaurant is far away from the user's current location, the actions of food delivery and taxi ride may be ranked lower than the action of making a reservation. If the mobile web browser 110 provides the user's third-party identifier or account information, the backend server 106 can prioritize service providers and inventory that are part of rewards/loyalty programs over those that do not offer cashback/rewards. In some cases, the backend server 106 may prioritize service providers providing instant offers and rebates.

Upon receipt of the data object, the mobile web browser 110 can render the actions, for example, within the web page the user is currently on. For example, the mobile web browser 110 can display a GUI element (such as an icon, button, or other GUI element) for each action. In some implementations, the user's interaction with the rendered actions enables the user to preview inventory information or links to the service providers that can fulfill the actions. For example, the user can tap or click an icon associated with an action and a window can pop-up to display available inventory or links to the service providers. Within the pop-up window, the user can tap or click an inventory item or a link to a service provider which can bring the user to the service provider's application, and the user can fulfill the action within the service provider's application. In some implementations, the user can fulfill the action within the native functionality of the mobile web browser 110 without switching to the service provider's application.

Consistent with the specific example provided above, if a user is on a restaurant web page, the mobile web browser 110 can send the restaurant URL to the backend server 106 and request a list of contextual actions associated with the restaurant web page. The backend server 106, based on the URL, may identify that contextual next actions, highly-relevant to the restaurant web page, can include making a reservation at the restaurant, requesting a ride to the restaurant, and food delivery from the restaurant. The backend server 106 can identify service providers for these actions and collect inventory information. For example, the backend server 106 can communicate with a transportation service provider server 108 (for example, UBER, LYFT, etc.) to obtain options for transportation from the user's current location to the restaurant, such as a number of cars currently available, type of each available car, estimated pickup time, estimated traveling time, and cost. The backend server 106 can also communicate with a reservation service provider server 108 (for example, OPENTABLE, WEBERVATIONS, PLANYO, etc.) to obtain options for reservation, such as available reservation times and party size at the restaurant.

The backend server 106 can send the identified next actions and associated inventory information to the MCD 102. Upon receiving, the mobile web browser 110 can present icons of next actions in the restaurant web page, for example, the mobile web browser 110 can display one icon indicating “ride with Uber” and another icon indicating “book with OpenTable”. In some implementations, the way the mobile web browser 110 presents icons of next actions appears native and is designed to be non-intrusive to the browsing experience of the user. For example, if the user clicks or taps the icon “book with OpenTable,” a window can pop-up and show multiple entries indicating available reservation times and party sizes at the restaurant, for example, one entry of “6:30 pm, 4 guests” and another entry of “7 pm, 2 guests.” The user can choose a reservation time and party size and click or tap on the corresponding entry, which switches the user to OPENTABLE's native application on the MCD 102 for the user to complete the reservation. In some implementations, when switching to a service provider's native application, the mobile web browser 110 can send certain context information to the service provider's native application. For example, if the user selected the inventory entry “7 pm, 2 guests,” the mobile web browser 110 can send this information to OPENTABLE's native application so that the contextual information can be populated in the native application for use by the user to make a specific reservation in OPENTABLE. In some implementations, the mobile web browser 110 can complete the reservation within the native functionality of the mobile web browser 110 without switching to a service provider's native application.

The mobile web browser 110 can present next actions to the user in various ways. In a first example, an icon can always be visible in the browser toolbar and changes color when an action is available. Tapping on the icon then presents the next actions. In a second example, the browser toolbar can change color when an action(s) is available. Tapping on the toolbar displays the identified next action(s). In a third example, a button is rendered in the small space directly above the browser footer toolbar or directly below the browser header toolbar but disappears during scrolling. As will be appreciated by those of ordinary skill in the art, other GUI presentation options consistent with this disclosure are possible. These other presentation options are also considered to be within the scope of this disclosure.

In some implementations, actions can be presented to the user with or without discounts or offers related to the completion of the action. Offers and/or discounts can be applied in the service provider at the time of transaction or can be applied to a loyalty service (either first party or third party) that the user is associated with and in the form of currency employed specific to that loyalty service. For example, an X % discount on a first purchase can be offered in an action button (that is, the GUI element of the action) and is automatically discounted in the provider application at the time of purchase, a Y % cashback can be offered in an action button and is awarded to the user within the browsers loyalty offering, a Z % cashback can be offered in an action button and is awarded in collaboration with a third-party cashback loyalty service that the user belongs to, or a number of bonus miles can be offered in an action button and is awarded to the user using the airline loyalty service the user belongs to.

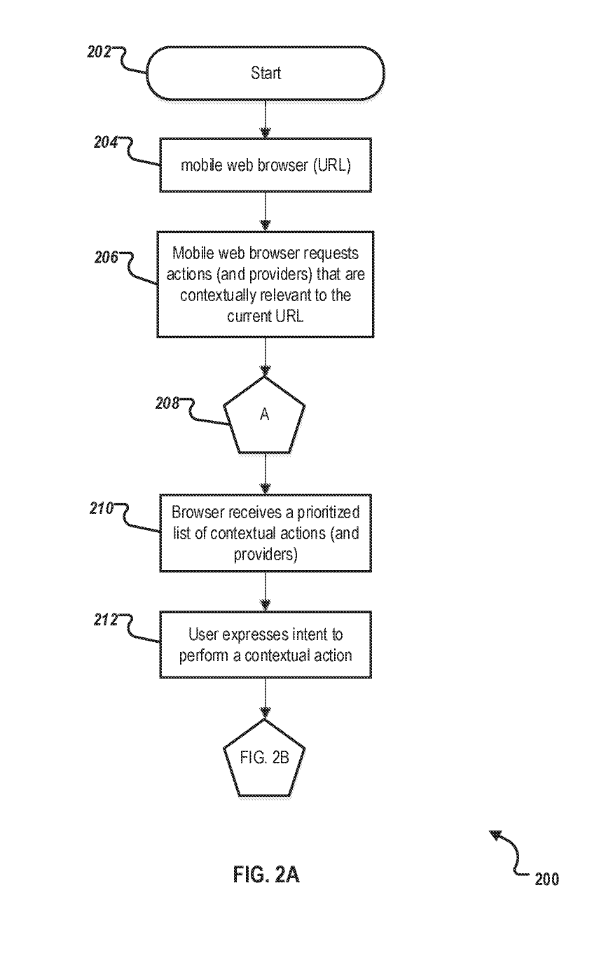

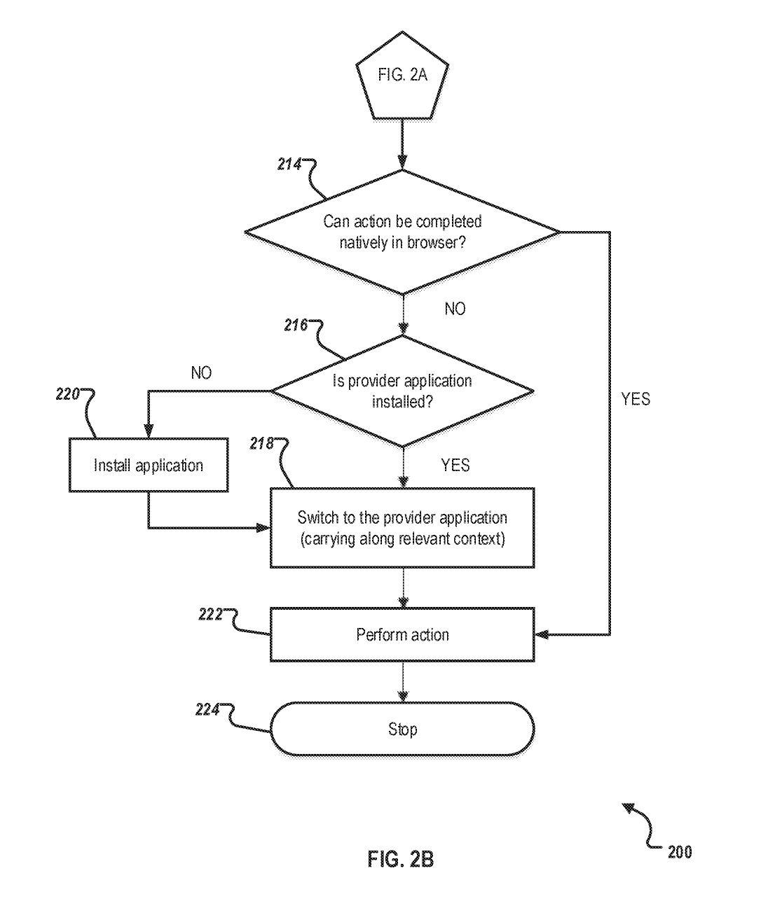

FIGS. 2A-2B and 3-4 are flow charts illustrating an example of methods for providing contextual actions based on web page content, according to an implementation. For clarity of presentation, the description generally describes associated methods in the context of some of all of the other figures associated with this disclosure. However, it will be understood that the methods illustrated in FIGS. 2A-2B and 3-4 (200 and 300-400, respectively) may be performed, for example, by any suitable system, environment, software, and hardware, or a combination of systems, environments, software, and hardware as appropriate. In an implementation, various steps of the methods illustrated in FIGS. 2A-2B and 3-4 can be run in parallel, in combination, in loops, or in any order.

FIGS. 2A and 2B are flow charts illustrating an example of a method 200 for providing contextual actions based on web page content, according to an implementation.

The method 200 starts at 202. From 202, method 200 proceeds to 204.

At 204, a user navigates to a URL in a mobile web browser. From 204, method 200 proceeds to 206.

At 206, the mobile web browser sends the current URL to the backend server for context analysis and determining next actions and service providers that are relevant to the context of the current URL. From 206, method 200 proceeds to 208.

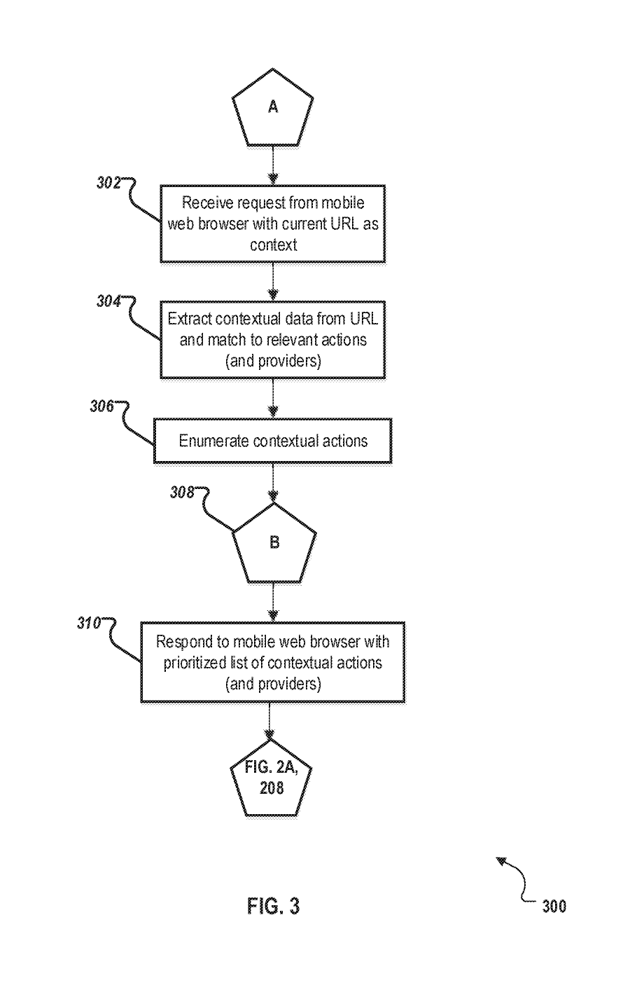

At 208 (as will be discussed in greater detail in FIG. 3), the backend server analyzes the current URL context and identifies next actions and service providers based on the URL. The backend server can prioritize the actions and service providers. For example, the backend server can only consider actions having a measure of contextual relevance to the current URL above a predetermined threshold and service providers that are able to provide service based on availability of inventory. The backend server can include the prioritized actions and service providers in a list. From 208, method 200 proceeds to 210.

At 210, the mobile web browser receives the prioritized list of contextual actions and service providers from the backend server and presents the list to the user. For example, the mobile web browser can display an icon or other graphical user interface element representing an action associated with a service provider. From 210, method 200 proceeds to 212.

At 212, the user expresses intent to perform a contextual action that has been presented by the mobile web browser. The user expression can be a tap, swipe, or click of an action icon, as presented natively by the mobile web browser. In response to the user expression, the mobile web browser can present inventory information of the selected service provider, such as real-time inventory, to the user. In some implementations, the user can select one or more items in the inventory. From 212, method 200 proceeds to 214 in FIG. 2B.

Turning now to FIG. 2B, at 214, the mobile web browser determines whether the action the user selected (for example, a purchase or reservation) can be completed within the native mobile web browser environment. In some implementations, the backend server can determine whether the action can be completed within the native mobile web browser and send an indication to the mobile web browser. For example, when the backend server returns a list of actions to the mobile web browser, the backend server can indicate whether each action can be completed within the native mobile web browser. The backend server may make the determination based on information returned from the provider API, data related to the provider that is stored in the backend databases, user device and operating system information, and potentially additional user information. For example, a user on an IOS device navigates to a page that is displaying a tennis racket, and the action presented to the user is “purchasing racket from jet.com”. The backend server can use provider information associated with JET.COM and knowledge of the user device and operating system to identify that a purchase with JET.COM is possible within the mobile web browser using APPLE PAY. When the user taps the icon for the action “purchasing racket from jet.com,” based on the indication from the backend server, the mobile web browser can automatically display a pop-up card or window with a button “pay with Apple Pay”. The user can tap the button “pay with Apple Pay” to validate the payment and complete the transaction. In some implementations, instead of the backend server sending indications to the browser, when the user taps the icon for the action “purchasing racket from jet.com,” the browser can communicate with the backend server and the backend server can instruct the mobile web browser to display a pop-up card with a button “pay with Apple Pay.”

If it is determined that the action can be completed within the native mobile web browser, method 200 proceeds to 222. Otherwise, if it is determined that the completion of the action requires navigation to a service provider's native application, method 200 proceeds to 216.

At 216, a determination is made whether the service provider's native application is installed on the MCD. If it is determined that the service provider's native application is not installed on the MCD, method 200 proceeds to 220. If it is determined that the service provider's native application is installed on the MCD, method 200 proceeds to 218.

At 220, the MCD is instructed to install the service provider's native application as a prerequisite to completing the contextual action. Note that this can, in some implementations, be accomplished by manual user prompts and actions, a fully automated process, or a combination of the two. From 220, method 200 proceeds to 218.

At 218, the mobile web browser switches the user to the service provider's native application. In some implementations, switching the mobile web includes the mobile web browser sending relevant context information to the service provider's native application. For example, the mobile web browser can send the inventory item the user has selected to the service provider's native application so that the service provider's native application can pre-populate appropriate data in the service provider's native application interface for use by the user (for example, for booking or purchasing the inventory item the user has selected). After 218, method 200 proceeds to 222.

At 222, the user performs the contextual action (either natively in the mobile web browser or within the service provider's native application). After 222, method 200 proceeds to 224. At 224, method 200 stops.

FIG. 3 is a flow chart illustrating an example of a method 300 for a backend server identifying contextual relevant actions, according to an implementation. FIG. 3 is entered at 302 from FIG. 2A at 208.

At 302, the backend server receives a request from the mobile web browser, the request including a URL (and other user-related information). From 302, method 300 proceeds to 304.

At 304, the backend server extracts contextual data from the URL, for example, using URL parsing, URL content evaluation, or other methods. Methods employed can include, but are not limited to: 1) Natural Language Processing (action intent inference based on a mathematical function that maps unstructured text (extracted from the URL content) to structured action/intent context); 2) Natural Entity Recognition and Disambiguation (entity identification (places, products, venues, artists, movies) based on a mathematical function that maps unstructured text (extracted from the URL content) and parsed URL hyperlinks (extracted from the URL content); 3) Entity Harmonization (cross-service entity identification based on a mathematical function that maps an entity identified in one service to the same entity in all other services (for example, matching a FOURSQUARE restaurant identifier to an OPENTABLE restaurant identifier when they represent the same restaurant)); and 4) Multi-page URL traversal (the application of 1 and 2 and 3 to linked web URL (extracted from the URL content) over multiple page “jumps”. The backend server can use the extracted contextual data to identify relevant actions and service providers. For example, based on the extracted (structured) contextual data, a mathematical function can be used to map the context to a list of actions and associated (potential) providers from which to query (using the API) for inventory. From 304, method 300 proceeds to 306.

At 306, the backend server enumerates all contextual actions. For example, a computer program or code can loop through a list of contextual actions, where the contextual actions comprise a string or identifier pointing to an internal (or backend) definition or storage of a contextual action and corresponding extracted contextual data. From 306, method 300 proceeds to 308.

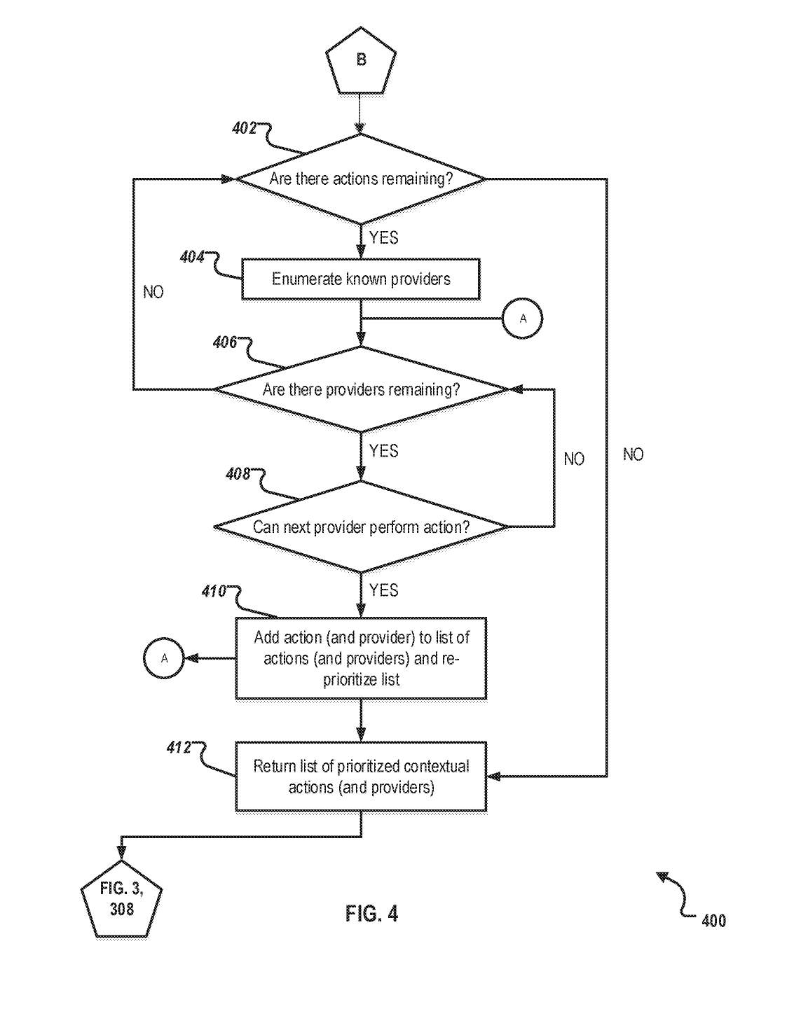

At 308 (discussed in greater detail in FIG. 4), for each enumerated contextual action, the backend server iterates over all potential service providers for that action, to identify action and provider pairs relevant to the user and the URL. For example, if the action is “book a table at Restaurant A,” the backend server can iterate over all providers that are known to the backend service for providing table reservations (for example, the backend server can have a database including the service providers that the backend service is aware of). For each potential provider, the backend server first checks if the information the backend service knows (for example, information from the backend database) can eliminate this provider from consideration (for example, the provider does not serve restaurants in the country the user is in). The backend server can then determine if the extracted contextual data can eliminate this provider from consideration (for example, the provider venue identifier for this restaurant is not part of the extracted context). If the provider is not eliminated in the last two steps, the backend server can query the provider API for inventory and return the pair of action and provider if inventory from the API is available. From 308, method 300 proceeds to 310.

At 310, the backend server returns a prioritized list of actions and providers to the mobile web browser. From 310, method 300 returns to 208 in FIG. 2A.

FIG. 4 is a flow chart illustrating an example of a method 400 for a backend server prioritizing contextual actions, according to an implementation. FIG. 4 is entered at 402 from 308 in FIG. 3.

At 402, the backend server determines whether there are more actions that need to be examined. If all actions have been examined, method 400 proceeds to 412. If there are more actions that need to be examined, method 400 proceeds to 404.

At 404, the backend server enumerates all service providers that are capable of completing the current action (that is, the action currently being examined), either natively, in the mobile web browser, or within a service provider's native application. From 404, method 400 proceeds to 406.

At 406, the backend server determines whether there are more providers remaining for the current action. If it is determined that all the providers associated with the current action have been examined (that is, no more providers), method 400 proceeds back to 402 to examine the next action. If it is determined that there are more providers remaining for the current action, method 400 proceeds to 408 to examine the next provider.

At 408, the backend server determines whether the next provider can complete the current action based on, for example, inventory availability. In some cases, if the real-time inventory is not available, the backend server may use data stored at the backend database (for example, a list of actions the provider has previously served) for determination. If it is determined that the provider cannot complete the action, method 400 proceeds back to 406 to examine the next provider. If it is determined that the next provider can complete the action, method 400 proceeds to 410.

At 410, the backend server adds the action and the provider that can complete the action to the list of actions and providers that will be returned to the user. In some implementations, the list of actions and providers can be re-prioritized each time a new action and provider pair is added. The prioritization can be based on, but is not limited to, inventory availability and a relevancy score indicating a relevance between an action and a provider. In some implementations, in the prioritized list a provider that has more inventory can be listed prior to a provider that has less inventory. From 410, method 400 proceeds to 412. In an alternative flow, after 410 and instead of proceeding to 412, method 400 can proceed back to 406 (see reference “A”).

At 412, the backend server returns the prioritized list of actions and providers to the mobile web browser. From 412, method 400 returns to FIG. 3 at 308.

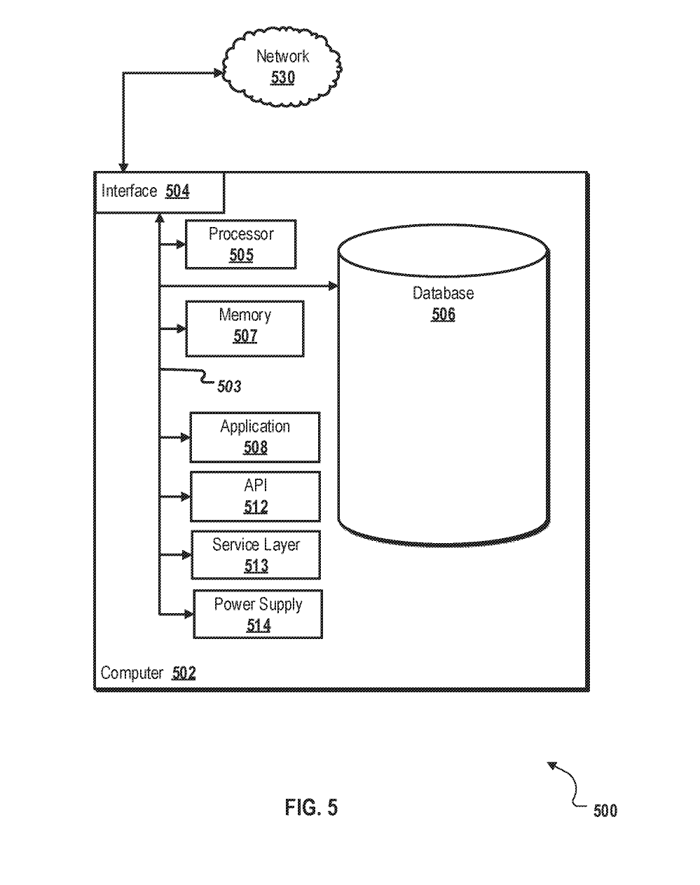

FIG. 5 is a block diagram illustrating an example of a computer-implemented system 500 used to provide computational functionalities associated with described algorithms, methods, functions, processes, flows, and procedures, according to an implementation of the present disclosure. In the illustrated implementation, system 500 includes a computer 502 and a network 530.

The illustrated computer 502 is intended to encompass any computing device such as a server, desktop computer, laptop/notebook computer, wireless data port, smart phone, personal data assistant (PDA), tablet computing device, one or more processors within these devices, another computing device, or a combination of computing devices, including physical or virtual instances of the computing device, or a combination of physical or virtual instances of the computing device. Additionally, the computer 502 can include an input device, such as a keypad, keyboard, touch screen, another input device, or a combination of input devices that can accept user information, and an output device that conveys information associated with the operation of the computer 502, including digital data, visual, audio, another type of information, or a combination of types of information, on a graphical-type user interface (UI) (or GUI) or other UI.

The computer 502 can serve in a role in a distributed computing system as a client, network component, a server, a database or another persistency, another role, or a combination of roles for performing the subject matter described in the present disclosure. The illustrated computer 502 is communicably coupled with a network 530. In some implementations, one or more components of the computer 502 can be configured to operate within an environment, including cloud-computing-based, local, global, another environment, or a combination of environments.

At a high level, the computer 502 is an electronic computing device operable to receive, transmit, process, store, or manage data and information associated with the described subject matter. According to some implementations, the computer 502 can also include or be communicably coupled with a server, including an application server, e-mail server, web server, caching server, streaming data server, another server, or a combination of servers.

The computer 502 can receive requests over network 530 (for example, from a client software application executing on another computer 502) and respond to the received requests by processing the received requests using a software application or a combination of software applications. In addition, requests can also be sent to the computer 502 from internal users (for example, from a command console or by another internal access method), external or third-parties, or other entities, individuals, systems, or computers.

Each of the components of the computer 502 can communicate using a system bus 503. In some implementations, any or all of the components of the computer 502, including hardware, software, or a combination of hardware and software, can interface over the system bus 503 using an application programming interface (API) 512, a service layer 513, or a combination of the API 512 and service layer 513. The API 512 can include specifications for routines, data structures, and object classes. The API 512 can be either computer-language independent or dependent and refer to a complete interface, a single function, or even a set of APIs. The service layer 513 provides software services to the computer 502 or other components (whether illustrated or not) that are communicably coupled to the computer 502. The functionality of the computer 502 can be accessible for all service consumers using this service layer. Software services, such as those provided by the service layer 513, provide reusable, defined functionalities through a defined interface. For example, the interface can be software written in JAVA, C++, another computing language, or a combination of computing languages providing data in extensible markup language (XML) format, another format, or a combination of formats. While illustrated as an integrated component of the computer 502, alternative implementations can illustrate the API 512 or the service layer 513 as stand-alone components in relation to other components of the computer 502 or other components (whether illustrated or not) that are communicably coupled to the computer 502. Moreover, any or all parts of the API 512 or the service layer 513 can be implemented as a child or a sub-module of another software module, enterprise application, or hardware module without departing from the scope of the present disclosure.

The computer 502 includes an interface 504. Although illustrated as a single interface 504 in FIG. 5, two or more interfaces 504 can be used according to particular needs, desires, or particular implementations of the computer 502. The interface 504 is used by the computer 502 for communicating with another computing system (whether illustrated or not) that is communicatively linked to the network 530 in a distributed environment. Generally, the interface 504 is operable to communicate with the network 530 and includes logic encoded in software, hardware, or a combination of software and hardware. More specifically, the interface 504 can include software supporting one or more communication protocols associated with communications such that the network 530 or interface's hardware is operable to communicate physical signals within and outside of the illustrated computer 502.

The computer 502 includes a processor 505. Although illustrated as a single processor 505 in FIG. 5, two or more processors can be used according to particular needs, desires, or particular implementations of the computer 502. Generally, the processor 505 executes instructions and manipulates data to perform the operations of the computer 502 and any algorithms, methods, functions, processes, flows, and procedures as described in the present disclosure.

The computer 502 also includes a database 506 that can hold data for the computer 502, another component communicatively linked to the network 530 (whether illustrated or not), or a combination of the computer 502 and another component. For example, database 506 can be an in-memory, conventional, or another type of database storing data consistent with the present disclosure. In some implementations, database 506 can be a combination of two or more different database types (for example, a hybrid in-memory and conventional database) according to particular needs, desires, or particular implementations of the computer 502 and the described functionality. Although illustrated as a single database 506 in FIG. 5, two or more databases of similar or differing types can be used according to particular needs, desires, or particular implementations of the computer 502 and the described functionality. While database 506 is illustrated as an integral component of the computer 502, in alternative implementations, database 506 can be external to the computer 502.

The computer 502 also includes a memory 507 that can hold data for the computer 502, another component or components communicatively linked to the network 530 (whether illustrated or not), or a combination of the computer 502 and another component. Memory 507 can store any data consistent with the present disclosure. In some implementations, memory 507 can be a combination of two or more different types of memory (for example, a combination of semiconductor and magnetic storage) according to particular needs, desires, or particular implementations of the computer 502 and the described functionality. Although illustrated as a single memory 507 in FIG. 5, two or more memories 507 or similar or differing types can be used according to particular needs, desires, or particular implementations of the computer 502 and the described functionality. While memory 507 is illustrated as an integral component of the computer 502, in alternative implementations, memory 507 can be external to the computer 502.

The application 508 is an algorithmic software engine providing functionality according to particular needs, desires, or particular implementations of the computer 502, particularly with respect to functionality described in the present disclosure. For example, application 508 can serve as one or more components, modules, or applications. Further, although illustrated as a single application 508, the application 508 can be implemented as multiple applications 508 on the computer 502. In addition, although illustrated as integral to the computer 502, in alternative implementations, the application 508 can be external to the computer 502.

The computer 502 can also include a power supply 514. The power supply 514 can include a rechargeable or non-rechargeable battery that can be configured to be either user- or non-user-replaceable. In some implementations, the power supply 514 can include power-conversion or management circuits (including recharging, standby, or another power management functionality). In some implementations, the power-supply 514 can include a power plug to allow the computer 502 to be plugged into a wall socket or another power source to, for example, power the computer 502 or recharge a rechargeable battery.

There can be any number of computers 502 associated with, or external to, a computer system containing computer 502, each computer 502 communicating over network 530. Further, the term “client,” “user,” or other appropriate terminology can be used interchangeably, as appropriate, without departing from the scope of the present disclosure. Moreover, the present disclosure contemplates that many users can use one computer 502, or that one user can use multiple computers 502.

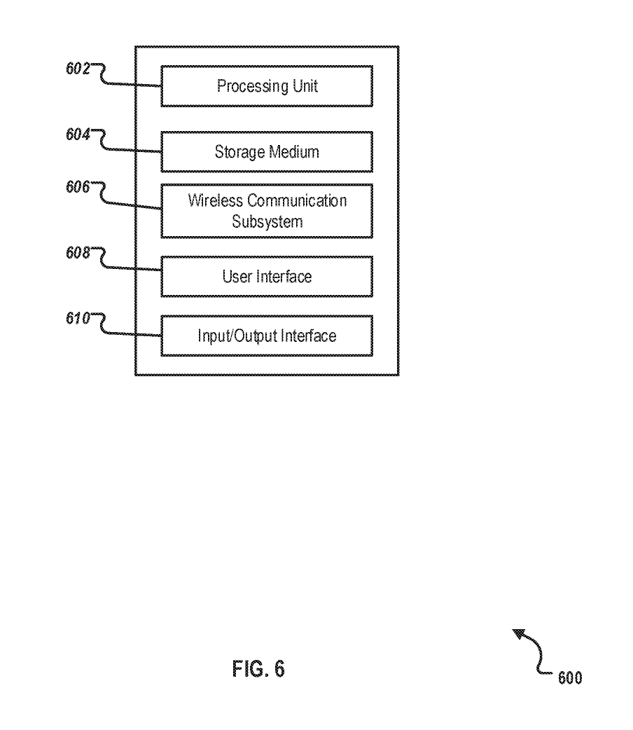

FIG. 6 is a block diagram illustrating an example of a MCD 600, according to an implementation. The example MCD 600 includes a processing unit 602, a computer-readable storage medium 604 (for example, a ROM or flash-type memory), a wireless communication subsystem 606, an interface 608, and an I/O interface 610. The processing unit 602 can include one or more processing components (alternatively referred to as “processors” or “central processing units” (CPUs)) configured to execute instructions related to one or more of the processes, steps, or actions described above in connection with one or more of the implementations disclosed herein. The processing unit 602 can also include other auxiliary components, such as random access memory (RAM) and read only memory (ROM). The computer-readable storage medium 604 can be embodied by a non-transitory medium configured to store an operating system (OS) of the device 600 and various other computer-executable software programs for performing one or more of the processes, steps, or actions described above.

The wireless communication subsystem 606 may be configured to provide wireless communications for data information or control information provided by the processing unit 602. The wireless communication subsystem 606 can include, for example, one or more antennas, a receiver, a transmitter, a local oscillator, a mixer, and a digital signal processing (DSP) unit. In some implementations, the subsystem 606 can support multiple input multiple output (MIMO) transmissions. In some implementations, the receivers in the wireless communication subsystems 606 can be an advanced receiver or a baseline receiver. Two receivers can be implemented with identical, similar, or different receiver processing algorithms.

The user interface 608 can include, for example, one or more of a screen or touch screen (for example, a liquid crystal display (LCD), a light emitting display (LED), an organic light emitting display (OLED), a microelectromechanical system (MEMS) display), a keyboard or keypad, a trackball, a speaker, and a microphone. The I/O interface 610 can include, for example, a universal serial bus (USB) interface. One of ordinary skill in the art will readily appreciate that various other components can also be included in the example MCD 600.

Described implementations of the subject matter can include one or more features, alone or in combination.

For example, in a first implementation, a computer-implemented method, comprising: receiving, at a server and from a mobile web browser executing on a mobile computing device, a Uniform Resource Locator (URL); identifying at least one contextual action based on at least content of a web page associated with the URL; identifying at least one service provider associated with the at least one contextual action; communicating with the at least one service provider for inventory information associated with the at least one contextual action; and sending, to the mobile web browser, at least one data object including information associated with the at least one contextual action and the inventory information.

The foregoing and other described implementations can each, optionally, include one or more of the following features:

A first feature, combinable with any of the following features, further comprising extracting contextual data from the URL.

A second feature, combinable with any of the previous or following features, further comprising enumerating at least one contextual action based on the extracted contextual data, wherein the at least one contextual action comprises a string or identifier pointing to a definition or storage of a contextual action and corresponding extracted contextual data.

A third feature, combinable with any of the previous or following features, further comprising iterating over potential service providers for the at least one contextual action to identify action and provider pairs relevant to a user and the URL.

A fourth feature, combinable with any of the previous or following features, further comprising considering, based on a predetermined threshold, only actions with a measure of contextual relevance to the URL.

A fifth feature, combinable with any of the previous or following features, wherein the at least one data object sent to the mobile web browser includes a prioritized list of actions and service providers contextually relevant to the received URL.

A sixth feature, combinable with any of the previous or following features, further comprising previewing the inventory information in response to an interaction with a graphical user interface element representing the at least one contextual action rendered in the mobile web browser.

In a second implementation, a non-transitory, computer-readable medium storing one or more instructions executable by a computer system to perform operations comprising: receiving, at a server and from a mobile web browser executing on a mobile computing device, a Uniform Resource Locator (URL); identifying at least one contextual action based on at least content of a web page associated with the URL; identifying at least one service provider associated with the at least one contextual action; communicating with the at least one service provider for inventory information associated with the at least one contextual action; and sending, to the mobile web browser, at least one data object including information associated with the at least one contextual action and the inventory information.

The foregoing and other described implementations can each, optionally, include one or more of the following features:

A first feature, combinable with any of the following features, further comprising one or more instructions to extract contextual data from the URL.

A second feature, combinable with any of the previous or following features, further comprising one or more instructions to enumerate at least one contextual action based on the extracted contextual data, wherein the at least one contextual action comprises a string or identifier pointing to a definition or storage of a contextual action and corresponding extracted contextual data.

A third feature, combinable with any of the previous or following features, further comprising one or more instructions to iterate over potential service providers for the at least one contextual action to identify action and provider pairs relevant to a user and the URL.

A fourth feature, combinable with any of the previous or following features, further comprising one or more instructions to consider, based on a predetermined threshold, only actions with a measure of contextual relevance to the URL.

A fifth feature, combinable with any of the previous or following features, wherein the at least one data object sent to the mobile web browser includes a prioritized list of actions and service providers contextually relevant to the received URL.

A sixth feature, combinable with any of the previous or following features, further comprising one or more instructions to preview the inventory information in response to an interaction with a graphical user interface element representing the at least one contextual action rendered in the mobile web browser.

In a third implementation, a computer-implemented system, comprising: one or more computers; and one or more computer memory devices interoperably coupled with the one or more computers and having tangible, non-transitory, machine-readable media storing one or more instructions that, when executed by the one or more computers, perform one or more operations comprising: receiving, at a server and from a mobile web browser executing on a mobile computing device, a Uniform Resource Locator (URL); identifying at least one contextual action based on at least content of a web page associated with the URL; identifying at least one service provider associated with the at least one contextual action; communicating with the at least one service provider for inventory information associated with the at least one contextual action; and sending, to the mobile web browser, at least one data object including information associated with the at least one contextual action and the inventory information.

The foregoing and other described implementations can each, optionally, include one or more of the following features:

A first feature, combinable with any of the following features, further performing one or more operations to extract contextual data from the URL.

A second feature, combinable with any of the previous or following features, further performing one or more operations to enumerate at least one contextual action based on the extracted contextual data, wherein the at least one contextual action comprises a string or identifier pointing to a definition or storage of a contextual action and corresponding extracted contextual data.

A third feature, combinable with any of the previous or following features, further performing one or more operations to iterate over potential service providers for the at least one contextual action to identify action and provider pairs relevant to a user and the URL.

A fourth feature, combinable with any of the previous or following features, further performing one or more operations to consider, based on a predetermined threshold, only actions with a measure of contextual relevance to the URL.

A fifth feature, combinable with any of the previous or following features, wherein the at least one data object sent to the mobile web browser includes a prioritized list of actions and service providers contextually relevant to the received URL.

A sixth feature, combinable with any of the previous or following features, further performing one or more operations to preview the inventory information in response to an interaction with a graphical user interface element representing the at least one contextual action rendered in the mobile web browser.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to a receiver apparatus for execution by a data processing apparatus. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be, or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with an operating system of some type, for example LINUX, UNIX, WINDOWS, MAC OS, ANDROID, IOS, another operating system, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and apparatus can also be implemented as, special purpose logic circuitry, for example, a CPU, an FPGA, or an ASIC.

Computers for the execution of a computer program can be based on general or special purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital video disc (DVD), CD-ROM, DVD+/−R, DVD-RAM, DVD-ROM, HD-DVD, and BLURAY, and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity, a multi-touch screen using capacitive or electric sensing, or another type of touchscreen. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, Frame Relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what can be claimed, but rather as descriptions of features that can be specific to particular implementations of particular inventions. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
receiving, at a server and from a mobile web browser executing on a mobile computing device, a Uniform Resource Locator (URL);
identifying at least one contextual action based on at least content of a web page associated with the URL;
identifying at least one service provider associated with the at least one contextual action;
communicating with the at least one service provider for inventory information associated with the at least one contextual action; and
sending, to the mobile web browser, at least one data object including information associated with the at least one contextual action and the inventory information.

2. The computer-implemented method of claim 1, further comprising extracting contextual data from the URL.

3. The computer-implemented method of claim 2, further comprising enumerating at least one contextual action based on the extracted contextual data, wherein the at least one contextual action comprises a string or identifier pointing to a definition or storage of a contextual action and corresponding extracted contextual data.

4. The computer-implemented method of claim 3, further comprising iterating over potential service providers for the at least one contextual action to identify action and provider pairs relevant to a user and the URL.

5. The computer-implemented method of claim 4, further comprising considering, based on a predetermined threshold, only actions with a measure of contextual relevance to the URL.

6. The computer-implemented method of claim 4, wherein the at least one data object sent to the mobile web browser includes a prioritized list of actions and service providers contextually relevant to the received URL.

7. The computer-implemented method of claim 1, further comprising previewing the inventory information in response to an interaction with a graphical user interface element representing the at least one contextual action rendered in the mobile web browser.

8. A non-transitory, computer-readable medium storing one or more instructions executable by a computer system to perform operations comprising:
receiving, at a server and from a mobile web browser executing on a mobile computing device, a Uniform Resource Locator (URL);
identifying at least one contextual action based on at least content of a web page associated with the URL;
identifying at least one service provider associated with the at least one contextual action;
communicating with the at least one service provider for inventory information associated with the at least one contextual action; and
sending, to the mobile web browser, at least one data object including information associated with the at least one contextual action and the inventory information.

9. The non-transitory, computer-readable medium of claim 8, further comprising one or more instructions to extract contextual data from the URL.

10. The non-transitory, computer-readable medium of claim 9, further comprising one or more instructions to enumerate at least one contextual action based on the extracted contextual data, wherein the at least one contextual action comprises a string or identifier pointing to a definition or storage of a contextual action and corresponding extracted contextual data.

11. The non-transitory, computer-readable medium of claim 10, further comprising one or more instructions to iterate over potential service providers for the at least one contextual action to identify action and provider pairs relevant to a user and the URL.

12. The non-transitory, computer-readable medium of claim 11, further comprising one or more instructions to consider, based on a predetermined threshold, only actions with a measure of contextual relevance to the URL.

13. The non-transitory, computer-readable medium of claim 11, wherein the at least one data object sent to the mobile web browser includes a prioritized list of actions and service providers contextually relevant to the received URL.

14. The non-transitory, computer-readable medium of claim 8, further comprising one or more instructions to preview the inventory information in response to an interaction with a graphical user interface element representing the at least one contextual action rendered in the mobile web browser.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving, at a server and from a mobile web browser executing on a mobile computing device, a Uniform Resource Locator (URL);
identifying at least one contextual action based on at least content of a web page associated with the URL;
identifying at least one service provider associated with the at least one contextual action;
communicating with the at least one service provider for inventory information associated with the at least one contextual action; and
sending, to the mobile web browser, at least one data object including information associated with the at least one contextual action and the inventory information.

16. The computer-implemented system of claim 15, further performing one or more operations to extract contextual data from the URL.

17. The computer-implemented system of claim 16, further performing one or more operations to:
enumerate at least one contextual action based on the extracted contextual data, wherein the at least one contextual action comprises a string or identifier pointing to a definition or storage of a contextual action and corresponding extracted contextual data; and
iterate over potential service providers for the at least one contextual action to identify action and provider pairs relevant to a user and the URL.

18. The computer-implemented system of claim 17, further performing one or more operations to consider, based on a predetermined threshold, only actions with a measure of contextual relevance to the URL.

19. The computer-implemented system of claim 17, wherein the at least one data object sent to the mobile web browser includes a prioritized list of actions and service providers contextually relevant to the received URL.

20. The computer-implemented system of claim 15, further performing one or more operations to preview the inventory information in response to an interaction with a graphical user interface element representing the at least one contextual action rendered in the mobile web browser.
